(19) United States
(12) Patent Application Publication
(10) Pub. No.: US 2004/0116275 A1
(43) Pub. Date: Jun. 17, 2004

(54) Filter body

(76) Inventors: Sigrid Benfer, Hilchenbach (DE); Dieter Blase, Mullangen (DE); Hans-Peter Feuerpeil, Schwabisch Gmund (DE); Jenny Hoffman, Riechberg (DE); Hans Olapinski, Aichwald (DE); Barbara Seling, Ellwangen (DE); Gerhard Tomandl, Freiberg (DE)

Correspondence Address: John F Hoffman, Baker & Daniels, Suite 800, 111 East Wayne Street, Fort Wayne, IN, 46802, US

(21) Appl. No.: 10/468,036

(22) PCT Filed: Feb. 15, 2002
(86) PCT No.: PCT/EP02/01624

(30) Foreign Application Priority Data
Feb. 17, 2001 (DE) 101 07 539.1

(51) Int. Cl. B01J 20/28

(52) U.S. Cl. 502/4

(57) ABSTRACT

The invention relates to a method for producing a membrane filter body comprising the following steps: at least one porous functional layer (H) which is made of zeolitic particles is provided; a liquid is applied to said functional layer (II), containing precursors suitable for forming zeolite; the functional layer (II) and the liquid disposed thereon are subjected to a pressure and a specific temperature in order to form a closed a molecular screening layer (I).

The invention involves a membrane for filtering liquids. A device of this type is described, for example, in DE 100 19 672 A1. It generally involves filter elements for cross-current filtration with a zeolite layer as the separating layer.

Filter elements can be flat elements, tube-shaped elements (mono-channel, multi-channel), though they can also be disk-shaped filter elements (rotor filters); the material which can form the support body that carries the separation layer can consist of porous, ceramic materials or of porous metals.

For each type of filter body, two requirements are always to be met: on the one hand, the throughput, i.e. the quantity of the volume passing through the filter medium, should be as large as possible. On the other hand, however, the separation performance or separating effect should be optimal, i.e. particles and/or molecules of a certain size should be separated from a fluid and/or larger molecules should be separated from smaller molecules (solid-liquid-gas-separation).

These two requirements contradict themselves. The larger the throughput is, the separating effect tends to be worse. This law applies especially when the particles and/or molecules to be separated are small. Here, “small” is understood to mean that the sizes of the particles/molecule fluctuate in the nano-range.

Filter bodies of the type discussed here are usually constructed of the following layers, and specifically, as seen in the throughput direction: First, a membrane layer is found. This layer performs the actual separating function. It is dominate for the filtration result. It generally has a relatively small thickness.

Next, at least one other layer follows which carries the membrane layer and accordingly is labeled as a “supporting layer”. The supporting layer essentially has no filtration function. It can be significantly thicker than the membrane layer.

The supporting layer is for its part carried by supporting bodies, which define the geometric structure (flat membrane/tube membrane/disk membrane).

As a material of the membrane layer, zeolite comes into consideration, and specifically in numerous variations. All zeolites contain aluminum and silicon oxides. They are known from the literature for fulfilling extreme separating functions, in which especially small particles and/or molecules should be separated from a suspension and/or solution. See JP 09131516-A. This document describes the way in which water can be separated from a mixture that contains water and organic or inorganic components. The separating membranes used in this process are constructed out of zeolite. They consist of thin films.

The manufacture of the zeolite membrane is done, for example, in the following way: Onto the supporting layer, an aqueous suspension made of aluminum silicate is applied, manufactured from colloidal silicon oxide, sodium aluminate, sodium hydroxide, and water. The layer thus formed and applied onto the supporting layer is then subjected to a hydrothermal treatment such that zeolite crystals begin to grow. In this process, however, only the pores of the supporting layer are filled with tiny zeolite crystals and become partially closed. Such a layer structure leads to small throughput capacitys, since the pores of the supporting layer lying beneath are filled up with a few μm of zeolites in the longitudinal direction and only approx. ⅓ of the geometric membrane surface is available as a throughput surface. A possibly extremely thin zeolite layer above it does not improve the small throughput capacity. A different manufacturing method for a zeolite layer (membrane) consists in that the surface of a supporting layer (supporting membrane) is contracted, made from an inorganic, possibly ceramic, material with a solution and/or suspension that forms zeolites and allows zeolite crystals to develop under hydrothermal conditions. Also here, a zeolite membrane forms, whereby at first gaps are present between the tiny zeolite crystals. These gaps lead to a poor separating effect. However, if the zeolite crystals are allowed to grow sufficiently long (growth occurs simultaneously in all crystals), then these gaps become closed and a membrane layer with an excellent selectivity is obtained. Now only the zeolite crystal structure is responsible for the separating effect, not the gaps between the zeolite crystals. The disadvantage of the zeolite membrane manufactured in this way is the small throughput capacity due to the high layer thickness.

In the literature, it has been reported from experiments how to create a zeolite membrane that is as thin as possible and at the same time is free of gaps between the zeolite crystals; this occurs by intentionally influencing the crystallization process whereby an attempt is made, instead of cultivating a few large individual crystals, to cultivate a multitude of very small crystals. The results of these experiments, however, have until now not yet led to satisfactory throughput results.

DE 696 08 128 T2 describes a filter element that contains a molecular filter layer. Next, the problem is also addressed that is peculiar to these membrane filter bodies—see the paragraph that spans pages 3 and 4. According to it, it is difficult to manufacture the zeolite layer of a membrane filter body of this type in such a way that it is completely closed and also stays closed.

Page 4 of the document mentioned, lines 12 to 22, deals with the state-of-the-art, with its disadvantages. According to it, a closed zeolite layer can be obtained, but if it has a large thickness. Instead of this, a second zeolite layer can also be applied to a first zeolite layer in the expectation that hollow spaces will occur in the two layers at different points. Both solutions have the disadvantage of a high material transport resistance and thus a low throughput.

The document mentioned itself recommends providing, in addition to the zeolite layer, an additional layer made of heat-resistant material that has a melting point of at least 1800 degrees Celsius. The material of this additional layer, however, is not a zeolite since a zeolite breaks down at the latest at 1000 degrees Celsius.

In the process, the heat-resistant material should serve to a certain extent as a gap stopper. This results from the fact that the molecular filter layer has gaps at first, according to this document.

The purpose of the invention is to create a filter body which has a high separating effect and which is especially suitable for the separation of particles and/or molecules in the nano-range, which has, however, at the same time only a very small thickness and thus an acceptable throughput.

This purpose is achieved by the characteristics of claim 1.

The invention provides for a porous functional layer made of zeolite particles. This is the core concept of the invention. The following is intended: If according to claim 1, a precursor suitable for zeolite formation is applied to the function layer made of zeolite particles, then a multitude of zeolite crystal nuclei form from the precursor material directly on the surface of the zeolite particles. These zeolite crystal nuclei then begin to grow. The crystal growth then occurs in all directions, thus not only in the direction to the resultant molecular filter layer, but also into the upper area of the function layer on its zeolite particles. The hollow spaces found there are closed soon so that a completely closed molecular filter layer made of zeolite crystals results.

The molecular filter layer consists of extremely small zeolite crystals which have grown both into the porous channels of the porous zeolite layers lying beneath it as well as into the layer lying above it. Thus, a continuous transition from porous to closed zeolite layer is obtained on its surface.

By the operation described—rapid growth of the zeolite crystals on all sides—a high guarantee for the freedom of this layer from pores, openings, or hollow spaces, is prevalent even for a small thickness of the molecular filter layer.

As can be seen, the instructions of the invention are extremely simple to carry out, with a large amount of technical success.

Examples for zeolites, both for the intermediate layer as well as for the cover layer, i.e. the layer on which the liquid to be treated first occurs, are depicted in the following table:

| | |
|---|---|
| Cancrinite | Na₆Al₆Si₆O₂₄CaCO₃2H₂O |
| Chabazite | (Ca, Na₂)˜₂Al₄Si₆O₂₄13H₂O |
| Erionite | (Ca, K₂, Na₂)˜₄Al₈Si₂₈O₇₂27H₂O |
| Faujasite | ˜Na₁₃Ca₁₁Mg₉K₂Al₅₆Si₁₃₇O₃₈₄235H₂O |
| Gmelinite | (Na, etc.)˜₈Al₈Si₁₆O₄₈24H₂O |
| Mazzite | K_{2.5}MG_{2.1}Ca_{1.4}Na_{0.3}Al₁₀Si₂₆O₇₂28H₂O |
| Mordenite | Na₈Al₈Si₄₀O₉₆24H₂O |
| Offretite | KcaMgAl₅Si₁₃O₃₆15H₂O |
| Sodalite | Na₆Al₆Si₆O₂₄2NaCl |

The invention is explained using the drawing.

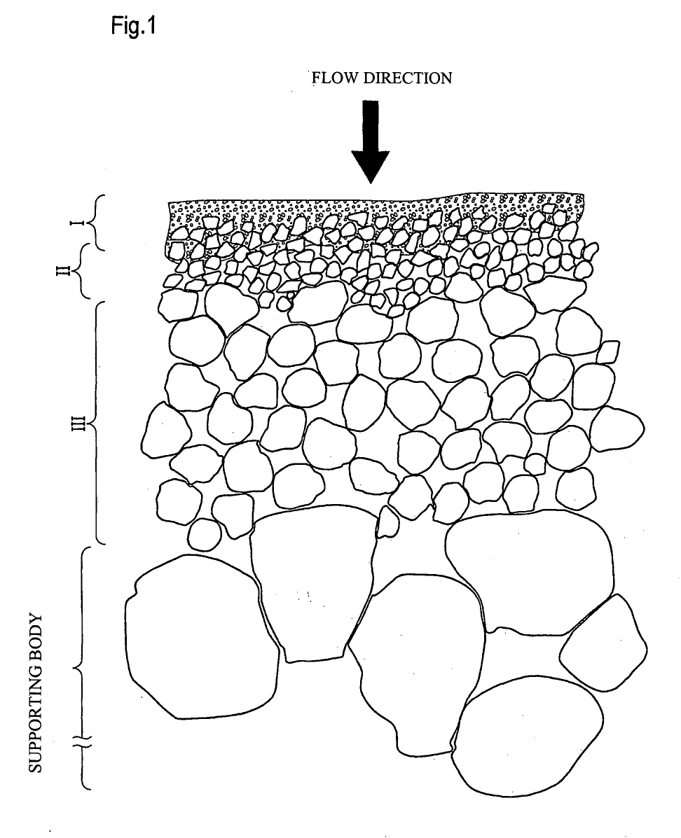

FIG. 1 shows a filter body in cross section

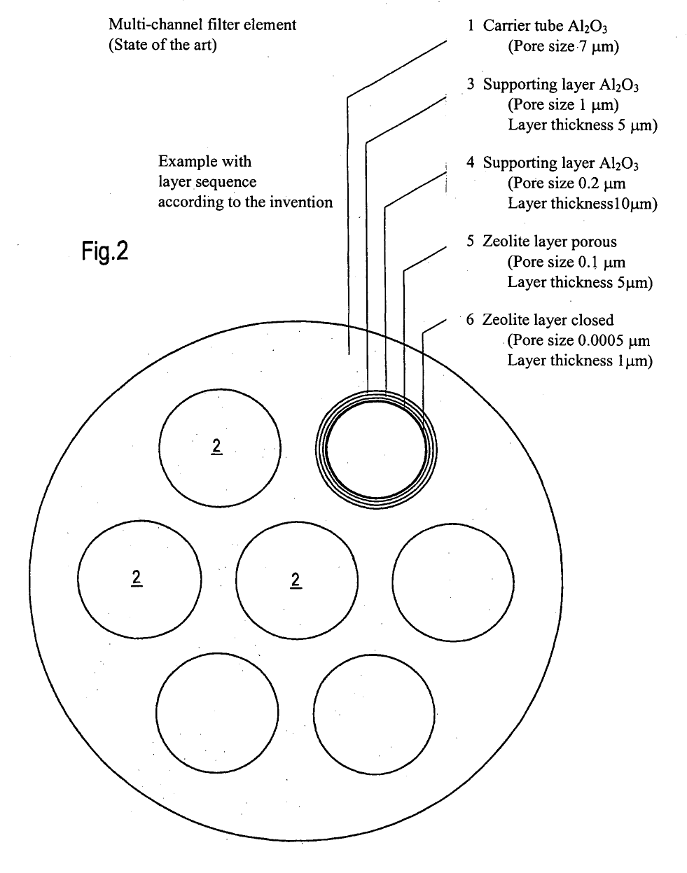

FIG. 2 shows a multi-channel filter element in cross section

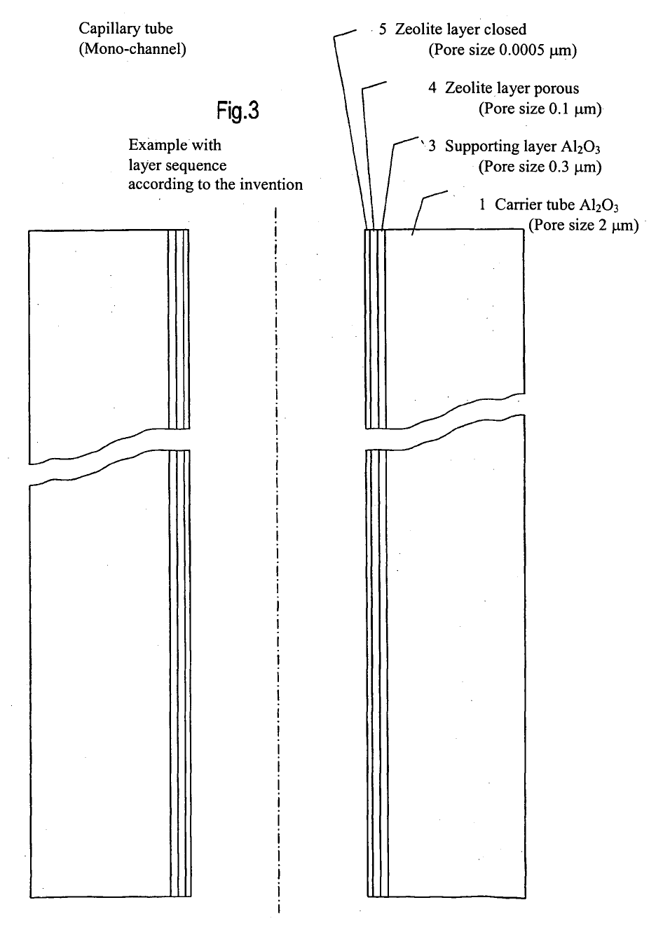

FIG. 3 shows a capillary tube in a longitudinal view

The filter body shown in FIG. 3 is constructed out of three layers I to III, and the supporting body. The arrow shows the direction of the flow of the liquid to be treated. The expression “liquid” is to be understood in the broadest sense. It can also thus involve any type of medium that is able to flow.

The three layers contain a molecular filter layer I, a function layer II, and one or more supporting layers III.

The supporting layer III is constructed in the case presented in a known way out of ceramic material. It has a relatively coarsely porous structure with pore sizes in the range from 1 μm to 0.01 μm. It can contain components like Al₂O₃, TiO₂, SiO₂.

All layers are constructed on a supporting body.

FIGS. 2 and 3 show how the invention appears in practice.

The multichannel filter element shown in FIG. 2 contains a rod-shaped carrier tube 1. It is made of porous Al₂O₃ with a pore size of 7 μm. This carrier tube has a multitude of axial channels 2 passing through it, which run parallel to each other.

On the inner surface of each channel, several layers are applied. From the outside to the inside, they are the following layers:

a supporting layer 3 made of Al₂O₃ with a pore size of 1 μm and a layer thickness of 30 μm

a supporting layer 4 made of Al₂O₃ with a pore size of 0.2 μm and a layer thickness of 10 μm

a porous zeolite layer 5 (corresponds to function layer II) with a pore size of 0.1 μm and a layer thickness of 5 μm

a zeolite layer 6 (corresponds to molecular layer I) with a pore size of 0.0005 μm and a layer thickness of 1 μm

Zeolite layer 5 is porous, whereas the zeolite layer 6 is closed.

The capillary tube shown in FIG. 3 is an additional embodiment example. This involves a carrier tube 1 made of Al₂O₃ with a pore size of 2 μm. In the following are the subsequent layers as seen from the outside to the inside:

a supporting layer 3 made of Al₂O₃ with a pore size of 0.3 μm

a zeolite layer 4 with a pore size of 0.1 μm

a zeolite layer 5 with a pore size of 0.0005 μm (0.5 nm).

The zeolite layer 4 is porous, whereas the zeolite layer 5 is closed.

FIGS. 2 and 3 with the corresponding explanations are only examples. Deviations of the numerical data and the layer arrangements of the supporting layers are variable.

The function layer II and all supporting layers III have no direct meaning for the actual filtration process. The particles are relatively large. In between there are pores, which together form throughput channels.

On the supporting layer III, the aforementioned function layer II made of zeolite particles is located. They have an average particle diameter which is, for example, in the range of 0.05-1 μm and pore sizes in the range of approx. 1 μm to 0.01 μm.

Function layer II is applied in the form of a suspension to the supporting layer III and sintered onto it. The function layer II can also be affixed to the supporting layer III by a hydrothermal treatment using precursor material additives.

The molecular filter layer I is of fundamental significance for the separating process. It consists of zeolite material, which, for example, can be selected from the table above. This zeolite material is applied in the form of a solution or a gel onto the function layer II, and treated under high pressure at temperatures of 80 to 300° C. at the corresponding equivalent pressure or a high pressure. 150° C. has proven to be a favorable temperature value.

Molecular filter layer I represents a closed crystalline zeolite layer. By the aforementioned treatment, the crystals are grown together in such a way that there are no more intercrystalline pores. The medium to be treated can thus only emerge through the crystal structure itself.

Molecular filter layer I is both pore-free as well as extremely thin because of the manufacturing conditions. Because it is thin, the desired throughput is relatively high.

1. Process for manufacturing a membrane filter body with the following process steps:
1.1 at least one porous function layer (II) is prepared from zeolite particles;
1.2 on the function layer (II), liquid is applied which contains precursors suitable for zeolite formation;
1.3 the function layer (II) and the liquid located on it are exposed to a pressure and a temperature in order to form a closed molecular filter layer (I).

2. Process according to claim 1, characterized in that the liquid is a gel or a suspension or a dispersion or a solution.

3. Process according to claim 1 or 2, characterized in that the zeolite particles of the function layer (II) are connected to each other so that a reinforced function layer (II) results.

4. Process according to one of the claims 1 to 3, characterized in that the porous function layer II is manufactured by sintering.

5. Process according to claim 4, characterized in that during sintering, a zeolite precursor is used as a sinter auxiliary agent.

6. Process according to claim 3, characterized in that in order to reinforce the function layer II, zeolite precursors are added to the zeolite particles in liquid form and they are converted into zeolite hydrothermally.

7. Process according to one of the claims 1 to 6, characterized in that the liquid is exposed to a temperature of 80 to 300 degrees Celsius.

8. Process according to one of the claims 1 to 6, characterized in that the liquid is exposed to a temperature of 120 to 160 degrees Celsius.

9. Process according to one of the claims 1 to 8, characterized in that the applied pressures are at least equal to the equivalence pressure of the liquid at the temperature involved.

10. Process according to one of the claims 1 to 9, characterized in that the function layer (II) is applied to at least one porous supporting layer (III).

11. Process according to one of the claims 1 to 10, characterized in that the function layer (II) is carried by at least one porous supporting layer (III) made from a different material than zeolite.

12. Membrane filter, containing a closed molecular filter layer (I), which results from a liquid containing zeolite precursors, and a porous function layer (II) carrying it, made of zeolite particles.

13. Process according to claim 1-12, characterized in that the molecular filter layer I and function layer II consist of the same zeolite type.

14. Process according to claim 1-12, characterized in that the molecular filter layer I and function layer II consist of different zeolite types.
